(19) United States
(12) Patent Application Publication
(10) Pub. No.: US 2006/0291530 A1
(43) Pub. Date: Dec. 28, 2006

(54) Treatment of CMP pad window to improve transmittance

(76) Inventors: Alexander Tregub, San Jose, CA (US); Jean M. Moran, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/165,689

(22) Filed: Jun. 23, 2005

(51) Int. Cl. G01N 25/00; G01N 25/20

(52) U.S. Cl. 374/45; 374/43

(57) ABSTRACT

A method to treat a polyurethane window on a chemical mechanical polishing pad comprises providing the window separate from the CMP pad, annealing the window to substantially recrystallize one or more hard segments found within the window, and attaching the window to the CMP pad. In some implementations, the polyurethane window may remain attached to the CMP pad during the annealing process. In such an implementation, the annealing temperature is kept below a glass transition temperature or a decomposition temperature for the materials used to form the CMP pad.

### BACKGROUND

During the manufacture of integrated circuits on semiconductor wafers, chemical mechanical polishing (CMP) processes are often used to planarize layers of deposited material. CMP is well known in the art and generally involves the use of a rotating polishing pad and an abrasive, corrosive slurry on a semiconductor wafer. After a material is deposited on the surface of a semiconductor wafer, the polishing pad and the slurry physically and chemically grind flat the microscopic topographic features until the material is planarized, thereby allowing subsequent processes to begin on a flat surface. In many cases the material is further polished by the polishing pad until the material is reduced to a predetermined thickness or until a layer of another material is exposed.

Although this is a well-known and regularly used process, CMP suffers from drawbacks. There are difficulties in ascertaining the end-point of a CMP process that result in a layer of material being under-polished or over-polished. One technique for detecting the end-point of a CMP process is to provide a pad window on the CMP polishing pad. The pad window is usually made from a semicrystalline polymer such as polyurethane. A focused optical beam, such as a laser, is directed through the pad window during the CMP process to monitor changes in the layer being polished. The optical beam provides electronic feedback to the CMP system to signal when the layer being polished undergoes any changes that signify the end-point of the CMP process.

The transmittance of the optical beam may be detrimentally affected by crystalline hard segments present within the polishing pad window. These hard segments affect the optical transmittance of the pad window by decreasing transmittance due to light scattering on the crystalline hard segments. This reduces the reliability of the end point detection method and often results in a layer being under-polished or over-polished. Accordingly, methods are needed to improve end-point detection during a CMP process to eliminate under-polishing or over-polishing of layers.

### BRIEF DESCRIPTION OF THE DRAWINGS

FIG. 1 illustrates a CMP pad with a window.

FIG. 2 is a method for detecting the presence of hard segments in a pad window.

FIG. 3 is method for treating a pad window containing hard segments in accordance with an implementation of the invention.

FIG. 4 is an alternate method for treating a pad window containing hard segments in accordance with an implementation of the invention.

### DETAILED DESCRIPTION

Described herein are systems and methods of improving the transmittance of a window in a chemical mechanical polishing (CMP) pad. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

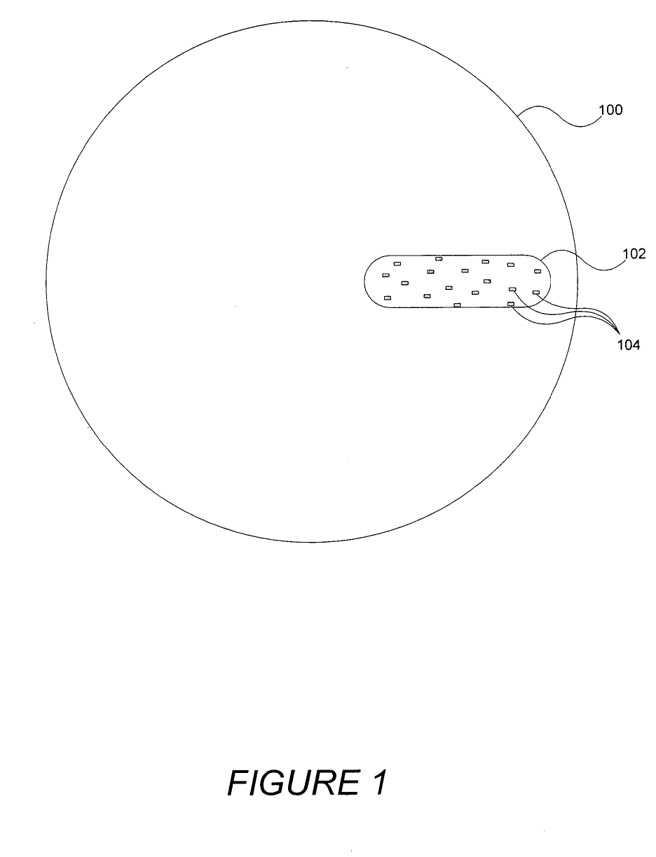

Implementations of the invention address improving the transmittance of a window in a CMP pad. FIG. 1 illustrates a CMP pad 100 having a window 102. The window 102 is generally formed from a semi-transparent material such as polyurethane and is used for CMP end-point detection processes. CMP pads 100 having a window 102 for end-point detection are well known in the art and are available from many vendors, including but not limited to Rohm and Haas Company of Philadelphia, Pa., Asahi Glass Co., Ltd. of Japan, and JSR Corporation of Japan.

Unfortunately, most untreated polyurethane windows 102 generally include random crystalline phases of polyurethane formed by hard segments 104. This is because polyurethanes are segmented block copolymers that generally show a two-phase structure in which hard segment microdomains, in sizes ranging from a few to hundreds of Angstroms, are dispersed in a matrix of soft segments. It should be noted that the hard segments 104 shown in FIG. 1 have been drawn relatively larger than normal to make them more clearly visible.

In a CMP end-point detection process using an optical beam such as a laser, the hard segments 104 tend to scatter the laser light and therefore decrease the optical transmittance of the pad window 102. This light scattering has an uncontrolled and unpredictable impact on the CMP process and may result in an over-polishing or an under-polishing of a layer on a substrate. Therefore, in accordance with the invention, an incoming CMP pad 100 having a pad window 102 may be analyzed for the presence of hard segments 104 and treated before use.

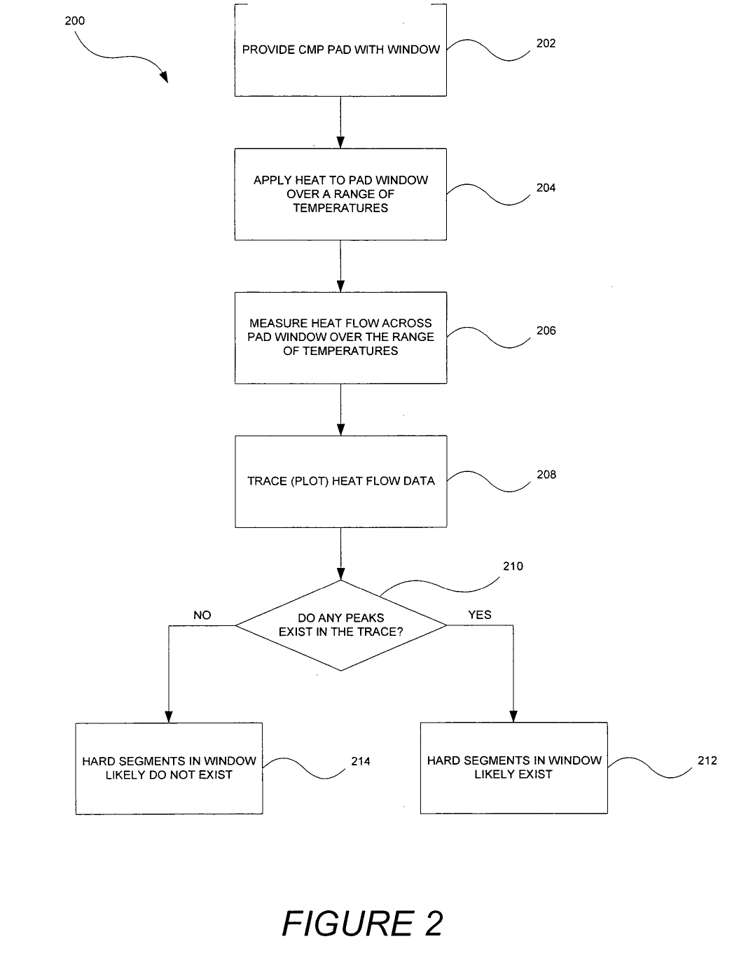

FIG. 2 provides a method 200 for detecting hard segments in accordance with an implementation of the invention. A CMP pad having a pad window is provided (202). A differential scanning calorimetry (DSC) apparatus may be used to analyze the provided CMP pad for hard segments. The DSC apparatus may be used to determine the glass transition temperature or the crystallization temperature of the polyurethane used to form the pad window. The DSC apparatus applies heat to the pad window over a range of temperatures (204) and then measures the heat flow across the pad window, such as the heat released or absorbed by the pad window, at various temperatures over that range (206). The measurement is typically in Watts/gram or Calories/gram.

A trace (i.e., a graphical plot) of the DSC data may be generated to graphically illustrate the heat transmitting behavior of the pad window over the temperature range (208). The trace of the DSC data may be inspected for peaks (210). If the pad window likely contains hard segments, the trace of the DSC data will tend to show a peak at a particular temperature (212). This temperature is generally the recrystallization temperature for the hard segments and the peak represents a sudden change in the structure of the pad window as the polyurethane hard segments in the window recrystallize and became substantially homogenous with the rest of the polyurethane in the window. If there are no peaks present in the trace, the pad window likely does not contain hard segments (214).

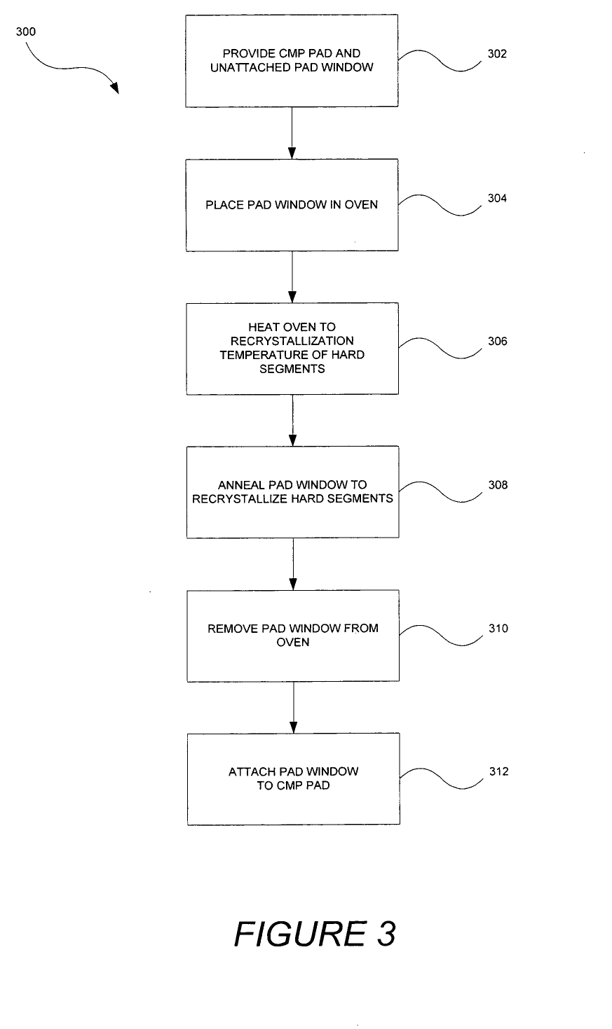

FIG. 3 is a method 300 for treating a pad window that contains hard segments in accordance with an implementation of the invention. A pad window with hard segments and a CMP pad are provided (302). Treatment of the pad window may occur prior to the pad window being affixed to the CMP pad. The CMP pad includes an opening upon which the pad window may be mounted. Generally the pad window is affixed to the CMP pad using a glue, another adhesive, and/or a special latch configuration on the CMP pad where the pad window is to be mounted. In some implementations, if the pad window is already affixed to the CMP pad, the pad window may be removed or detached from the CMP pad prior to treatment.

The pad window is then placed in an oven for an annealing process (304). In some implementations, the oven is heated to an annealing temperature that corresponds to the recrystallization temperature of the hard segments (306). In other implementations, the oven may be heated to an annealing temperature that exceeds the recrystallization temperature of the hard segments. In various implementations, the oven may be preheated prior to the pad window being placed inside the oven, or the oven may be heated after the pad window is placed inside. Heating the oven after the pad window is placed inside allows the pad window to be heated at a more gradual pace.

The recrystallization temperature of the hard segments may be determined using the DSC apparatus as described. As noted above, a trace of the DSC data for the pad window will tend to show a peak at a particular temperature, and that temperature peak generally corresponds to the recrystallization temperature for the hard segments.

For certain conventional pad windows formed of polyurethane materials, such as pads known in the industry as soft polyurethane pads, it has been shown that a temperature in the range of 120° C. to 180° C. is sufficient for causing a recrystallization of the hard segments. In some implementations, a temperature around 150° C. may be used as the annealing temperature.

The pad window is annealed in the oven for a period of time that is sufficient to recrystallize a substantial portion of the hard segments (308). This period of time may be determined by trial and error, and is dependent on how much improvement in the optical transmittance of the pad window is desired. The annealing time is also dependent on the temperature of the oven. At higher temperatures, for instance, the annealing time will generally be shorter. To a certain extent, a longer annealing time will result in a greater improvement in optical transmittance. After a certain period of time, however, substantially all of the hard segments will have recrystallized and further improvement cannot be attained.

For certain conventional pad windows formed of polyurethane materials, for instance soft polyurethane pads, it has been shown that an annealing time that ranges from a few seconds to several hours is sufficient for causing a recrystallization of a sufficient number of the hard segments. In implementations where an annealing temperature of around 150° C. is used, the annealing time may range from 15 minutes to 25 minutes.

The window is then removed from the oven (310) and attached to the CMP pad (312). In some implementations, the window may be cooled prior to being attached to the CMP pad. Generally a glue or another adhesive is used to affix the pad window to the CMP pad. In other implementations, mechanical means may be used such as a special latch configuration on the CMP pad. Other methods for attaching the pad window to the CMP pad may be used as well.

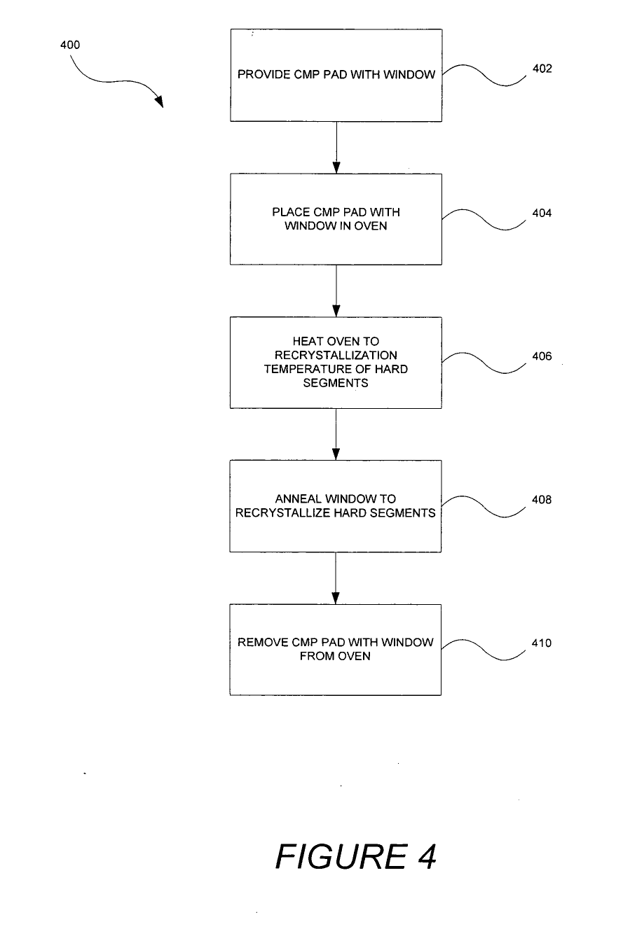

In another implementation of the invention, the window is not removed from the CMP pad for the annealing process. FIG. 4 is one implementation of such a method 400. A CMP pad having a pad window with hard segments is provided (402). The pad window remains attached to the CMP pad. The CMP pad having the window is then placed in an oven for an annealing process (404). In some implementations, the oven is heated to an annealing temperature that corresponds to the recrystallization temperature of the hard segments (406). In other implementations, the oven may be heated to an annealing temperature that exceeds the recrystallization temperature of the hard segments. Again, the oven may be preheated or the oven may be heated after the CMP pad is placed inside.

In implementations of the invention, the annealing temperature must remain below the temperature of any major transitions on the CMP pad, such as the glass transition temperature or the decomposition temperature of materials used to form the CMP pad surface. The temperature should also remain below any temperatures that may soften or even degrade any adhesive used to affix the pad window to the CMP pad. For many commonly used CMP pads in the industry, an annealing temperature around 150° C. is appropriate.

The pad window is annealed in the oven for a period of time that is sufficient to recrystallize a substantial portion of the hard segments (408). As mentioned above, this period of time is dependent on how much improvement in the optical transmittance of the pad window is desired and on the annealing temperature. The CMP pad may then be removed from the oven (410).

It has been shown that the annealing process described above has substantially no effect on the polishing properties of the CMP pad. A CMP process carried out using a CMP pad annealed as described in FIG. 4 will perform substantially the same as a non-annealed CMP pad. As described above, because the annealing temperature is kept below the glass transition temperature or decomposition temperature of the materials used on the surface of the CMP pad, the CMP pad remains substantially unaffected.

Table 1 provides data collected by the inventors regarding the optical transmittance of the CMP pad window before and after the annealing methods of the invention are carried out. The data in Table 1 was collected using an N&K tool using a wavelength of around 650 nm. A wavelength of 650 nm was chosen because many CMP end-point detection tools use a red laser with a wavelength of 650 nm. The transmittance of the pad window was measured before and after the annealing process. The annealing process was performed as described above at a temperature of 150° C. for 20 minutes.

TABLE 1
Transmittance of the CMP pad window

| | Transmittance | Transmittance | % |
|---|---|---|---|
| Sample No. | BEFORE Annealing | AFTER Annealing | Difference |
| 1 | 0.668 ± 0.010 | 0.767 ± 0.0143 | −15% |
| (hard segments) | | | |
| 2 | 0.753 ± 0.000 | 0.753 ± 0.000 | 0% |
| (no hard | | | |
| segments) | | | |

For Sample No. 1 which had a window that contained hard segments, annealing the window in accordance with implementations of the invention caused the transmittance of Sample No. 1 to increase by approximately 15%. This is attributed to the recrystallization of the hard segments into a more homogenous form with the polyurethane of the window. For Sample No. 2, which contained no hard segments, the annealing process produced no change in the transmittance properties. Because Sample No. 2 contained no hard segments, its transmittance is comparable to the transmittance of Sample No. 1 after it has been annealed to remove the hard segments.

The data shown in Table 1 also confirms that the existence of hard segments in the window causes a reduction in transmittance. This is shown by comparing the transmittance of Sample No. 1 to Sample No. 2 prior to the annealing process.

Accordingly, methods to improve the optical transmittance of CMP pad windows have been described. Implementations of the invention enable the optical transmittance of pad windows to be stabilized and made uniform for all incoming CMP pads. This in turn reduces the likelihood of over-polishing and/or under-polishing of material layers during a CMP process. As described, the optical transmittance of the pad window may be improved through various annealing processes.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A method comprising:
providing a window for a chemical mechanical polishing (CMP) pad;
annealing the window; and
attaching the window to a CMP pad.

2. The method of claim 1, wherein the window comprises a polyurethane material having at least one hard segment.

3. The method of claim 2, wherein the annealing of the window comprises annealing the window at a recrystallization temperature of the polyurethane material for a time sufficient to substantially recrystallize the hard segment.

4. The method of claim 2, wherein the annealing of the window comprises annealing the window at a temperature greater than the recrystallization temperature of the polyurethane material for a time sufficient to substantially recrystallize the hard segment.

5. The method of claim 1, wherein the annealing of the window comprises annealing the window at a temperature between 100° C. and 200° C. for a time between 1 minute and 1 hour.

6. The method of claim 1, wherein the annealing of the window comprises annealing the window at a temperature between 140° C. and 160° C. for a time between 15 minutes and 40 minutes.

7. The method of claim 1, wherein the attaching of the window to the CMP pad comprises using an adhesive to affix the window to the CMP pad.

8. The method of claim 1, wherein the attaching of the window to the CMP pad comprises using a latch configuration on the CMP pad to affix the window to the CMP pad.

9. The method of claim 1, wherein the annealing process is carried out in an oven.

10. A method comprising:
providing a window for a chemical mechanical polishing (CMP) pad;
applying heat to the window over a range of temperatures;
measuring the heat flow across the window over the range of temperatures; and
analyzing the measurements to determine whether the window includes one or more hard segments.

11. The method of claim 10, wherein the window comprises a polyurethane material.

12. The method of claim 10, wherein the applying of the heat and the measuring of the heat flow are performed using a differential scanning calorimetry apparatus.

13. The method of claim 10, wherein the analyzing of the measurements comprises plotting the measurements to generate a trace and analyzing the trace to identify peaks in the trace.

14. The method of claim 13, wherein the probability that the window includes hard segments is high if a peak is identified.

15. The method of claim 13, wherein the probability that the window includes hard segments is low if a peak is not identified.

16. The method of claim 13, further comprising determining the recrystallization temperature of the window, wherein an identified peak in the trace provides the recrystallization temperature.

17. A method comprising:
providing a chemical mechanical polishing (CMP) pad having a window; and
annealing the CMP pad and window.

18. The method of claim 17, wherein the window comprises a polyurethane material having at least one hard segment.

19. The method of claim 18, wherein the annealing of the CMP pad and window comprises annealing the CMP pad and window at a temperature that is below a glass transition temperature or a decomposition temperature for materials used to form the CMP pad but is sufficient to recrystallize the hard segment.

20. The method of claim 18, wherein the annealing of the CMP pad and window comprises annealing the CMP pad and window at a temperature between 140° C. and 160° C. for a time between 15 minutes and 40 minutes.
